(19) United States
(12) Patent Application Publication
(10) Pub. No.: US 2011/0113361 A1
(43) Pub. Date: May 12, 2011

(54) ADJUSTMENT PRESETS FOR DIGITAL IMAGES

(75) Inventors: Nikhil Bhatt, Cupertino, CA (US); Mark Lee Kawano, San Mateo, CA (US); Blake Seely, San Francisco, CA (US)

(73) Assignee: APPLE INC., Cupertino, CA (US)

(21) Appl. No.: 12/614,353

(22) Filed: Nov. 6, 2009

(51) Int. Cl. G06F 3/048; G09G 5/00; H04N 5/76

(52) U.S. Cl. 715/781; 345/619; 345/643; 348/231.99; 715/843; 715/862

(57) ABSTRACT

Processes and systems are presented, for previewing and applying adjustment presets to digital images. The disclosed processes enable a user to preview selected adjustment presets before applying the previewed adjustment presets to the digital image. One or more preview image frames to display the effect of corresponding one or more adjustment presets applied to the digital image can be presented to the user simultaneously with the original (i.e., un-adjusted) digital image.

### BACKGROUND

This specification relates to previewing and applying adjustment presets to digital images.

Image processing applications allow a user to import digital images, process the imported digital images, publish the processed images on the web or in print, and export or back up the processed digital images. Examples of image processing operations are editing, adjusting and retouching of the digital images. A user can apply the adjustment controls available within an image processing application to emulate desired looks and styles for the adjusted images. To compare a desired number of looks and styles for a given digital picture, the user can begin by adjusting the given digital image to create a first look or style. Upon inspecting the adjusted digital image, the user may undo the first adjustment to re-obtain the un-adjusted digital image. The user can cycle through the adjusting, inspecting and undoing steps to settle on a desired look or style.

### SUMMARY

This specification describes processes and systems for previewing and applying adjustment presets to digital images. The disclosed processes enable a user to preview selected adjustment presets before applying the previewed adjustment presets to the digital image. One or more preview image frames to display the effect of corresponding one or more adjustment presets applied to the digital image can be presented to the user simultaneously with the original (i.e., un-adjusted) digital image.

In general, one aspect of the subject matter described in this specification can be implemented in processes that include the actions of displaying a digital image in a first image frame of a user interface of the digital image manipulation application. A plurality of adjustment presets available to apply to digital images can be presented in the user interface. Potentially interest by a user of the digital image manipulation application in applying one or more adjustment presets to the digital image can be determined. Previews of how the digital image appears with the corresponding one or more adjustment presets applied can be generated in one or more other image frames. A digital image includes either an individual still image or a frame of a movie.

These and other implementations can include one or more of the following features. The user interface can be a graphical user interface (GUI), and the one or more image frames can consist of a second image frame. The generated preview image can be displayed in the second image frame, and can change dynamically in response to indicating another adjustment preset upon hovering a cursor over other adjustment preset in a GUI list. In response to user selection of one of the adjustment presets in the GUI list, the digital image can be adjusted according to the one adjustment preset. The adjusted digital image can be displayed in the first image frame. The second image frame can be removed from the GUI. The one adjustment preset can be modified by receiving first changes to one or more characteristics of the one adjustment preset. Further, a mask can be received to define a second region of the adjusted digital image. Furthermore, second changes can be received to one or more characteristics of the one adjustment preset to be applied only to the second region. The modified one adjustment preset can be saved to a new adjustment preset. In addition, the new adjustment preset can be added to the plurality of adjustment presets available to apply to digital images.

In some implementations, a particular adjustment preset can be configured to change a corresponding characteristic of the digital image by a predetermined value, independently of a corresponding characteristic value of the digital image. Additionally, the particular adjustment preset can be configured to change, in an algorithmic manner, a corresponding characteristic of the digital image to a predetermined value, independently of a corresponding characteristic value of the digital image.

In some implementations, generating the preview image includes identifying a first region of the image based on a mask of the first region. The mask of the first region may be included in a particular adjustment preset. The generating further includes applying the particular adjustment preset to the identified first region. The mask of the first region can be highlighted in the generated preview image prior to applying the particular adjustment preset to the identified first region.

In some implementations, the process further includes determining that the user is potentially interested in applying a second adjustment preset after having applied a first adjustment preset to the digital image. The first adjustment preset is configured to adjust a first characteristic of an image, and the second adjustment preset is configured to adjust a second characteristic of the image. The second adjustment preset can be added to the first adjustment preset previously applied to the digital image, if the first and second characteristics of the image have no common elements. The first adjustment preset previously applied to the digital image can be replaced by the second adjustment preset, if the first and second characteristics of the image have common elements.

According to another aspect, the described subject matter can also be implemented in a system including a storage device for storing media content containing a digital image. The system further includes a computing device to execute a digital image manipulation application. The application is configured to perform operations including displaying the digital image in an image frame of a user interface of the digital image manipulation application. A plurality of adjustment presets available to apply to digital images can be provided. The application can receive from a user an indication of potential interested in applying one or more adjustment presets to the digital image. One or more previews of the digital image adjusted with the corresponding one or more adjustment presets can be displayed in at least another image frame.

These and other implementations can include one or more of the following features. The adjustment presets can be listed in a drop-down menu in the user interface. New preview images can be displayed in a second image frame disposed adjacently to corresponding adjustment presets as the user moves a cursor through the drop-down menu from one adjustment preset menu item to another adjustment preset menu item. Additionally, the drop-down menu further includes a menu item to simultaneously display the one or more other image frames which show the generated previews corresponding to the one or more adjustment presets.

In some implementations, the system may include a memory device in communication with the computing device. The application can be configured to obtain the digital image from the memory device. In addition, the system may include an imaging device in communication with the computing device. The application can be further configured to acquire the digital image using the imaging device. A predetermined adjustment can be automatically selected from among the plurality of adjustments available to apply to digital images. The automatically selected predetermined adjustment can be applied to the acquired image.

According to another aspect, the described subject matter can also be implemented in a computer readable medium encoded with a computer program. The program includes instructions that when executed by a processor of a computing device cause the processor to perform operations including displaying a digital image in a primary image frame of a user interface. A plurality of adjustment presets available to apply to digital images can be provided in the user interface. A determination can be made that a user of the computer program is potentially interested in applying one or more of the plurality of adjustment presets to the digital image. Previews of how the digital image appears with the corresponding one or more adjustment presets applied can be generated in one or more secondary image frames. The digital image in the primary image frame may remain unchanged in response to generation of preview images.

These and other implementations can include one or more of the following features. The one or more secondary image frames can be spatially separated and distinct from primary image frame. To determine that the user is potentially interested in a particular adjustment preset the processor is instructed to detect that user has positioned a cursor over a menu item corresponding to the particular adjustment preset. A preview image can appear in a secondary image frame disposed adjacently to the corresponding menu item. The preview image can be transient and can go away as soon as user moves the cursor off that menu item. The displaying and the removing of the preview image can occur in real time from the user's perspective.

Particular aspects of the subject matter described in this specification can be implemented to realize one or more of the potential advantages listed below. The processes disclosed in this specification can be used to preview and apply professional imaging effects in a graphical user interface. The disclosed processes can be used to instantly apply combinations of adjustment settings, including auto-exposure and auto-levels. A user can instruct the application to apply the adjustment presets to digital images loaded in the application, or the adjustment presets can be applied automatically as the images are being imported in the application.

The processes described in this specification can be used to apply a sequence of adjustments in add-mode, to combine the effects of the successive adjustments. Alternatively, the disclosed processes can be used to apply the sequence of adjustments in remove-mode, to remove the effects of earlier applied adjustments and retain the effects of the last-applied adjustment. The disclosed application allows the user to choose between applying the sequence of adjustments in add-mode or in replace-mode.

Additionally, the adjustment presets described in this specification can be applied to the entire image or to portions of the image selected using a mask (e.g., a brushing mask, or a rectangular mask.) The adjustment settings and the mask can be saved as part of a new adjustment preset.

Details of one or more implementations are set forth in the accompanying drawings and the description below. Other features and advantages will be apparent from the description and drawings, and from the claims.

### DESCRIPTION OF DRAWINGS

FIG. 1 shows a block diagram of an example system including a digital computer in communication with a digital camera and a storage device storing digital images.

FIGS. 2A-2B show example user interfaces of an application for previewing and applying adjustment presets to a digital image.

FIGS. 3A-3B are flow charts of an example process for previewing and applying adjustment presets to a digital image.

FIGS. 4A-4B are flow charts of aspects of the example process for applying adjustment presets to a digital image.

FIG. 5 is a flow chart of aspects of the example process for previewing and applying adjustment presets to a digital image.

FIG. 6 shows an additional user interface of the application for previewing and applying adjustment presets to a digital image.

FIG. 7A shows a user interface of the application for applying adjustment presets to a set of digital images in batch mode.

FIG. 7B is a flow chart of an example process for applying adjustment presets to a set of digital images in batch mode.

Like reference symbols in the various drawings indicate like elements.

### DETAILED DESCRIPTION

The techniques and systems disclosed in this specification can be implemented in the APERTURE® software (available from Apple Inc., of Cupertino, Calif.) for previewing and applying adjustment presets to digital images. Throughout the specification, both individual still images as well as digital images in the form of frames of a movie are referred to as digital images.

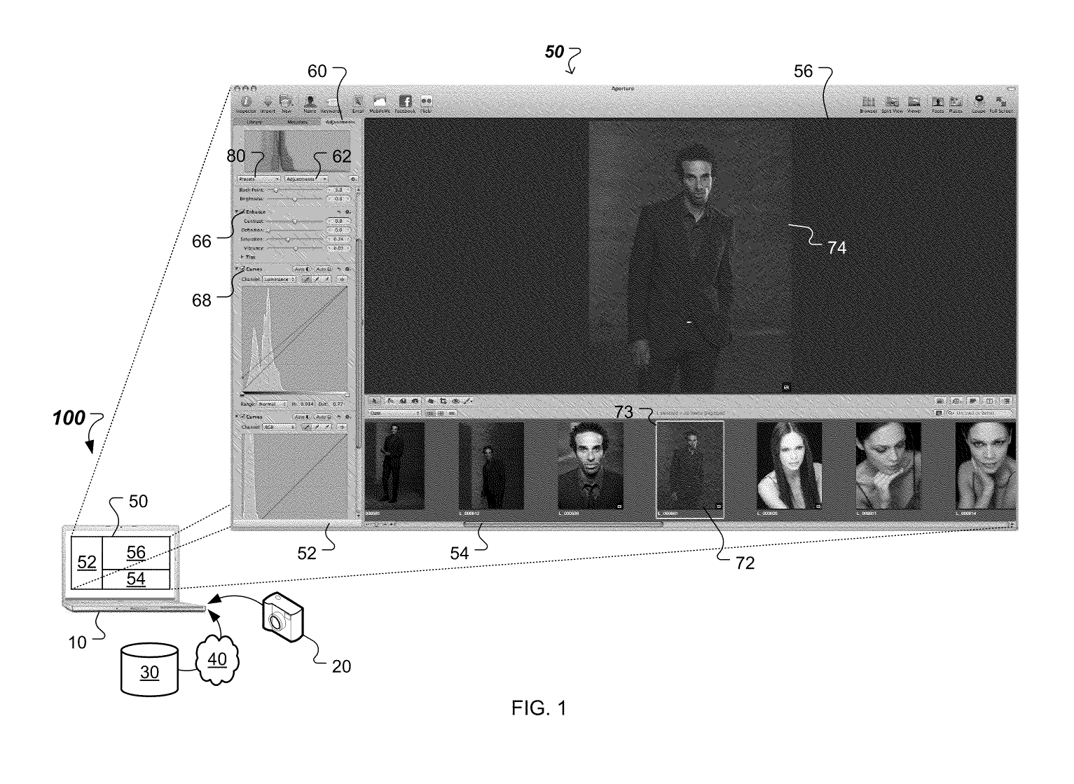

FIG. 1 shows a block diagram of an example system 100 including a digital computer 10 in communication with a digital camera 20 and a storage device 30 storing digital images.

The digital computer 10 can be a laptop computer, a workstation or a server computer. In some implementations, the digital camera 20 and the storage device 30 storing digital images can be coupled to the digital computer 10 using a variety of known technologies (e.g., USB, FireWire®, RS 232). In other implementations, the storage device 30 storing digital images can be located remotely from the digital computer 10 and be operated as part of a cloud service. In such implementations, the digital computer 10 can communicate with the storage device 30 via a communication network 40, e.g., the internet. The connection between the digital computer 10 and the network-based storage device 30 can be implemented as a wired or wireless network connection.

A software interface 50 of a digital image manipulation application running on the digital computer 10 is configured to browse through, to display and to process digital images received from the digital camera 20 and from the storage device 30. In some implementations, the foregoing digital images may be received automatically, e.g., upon establishing a connection with the digital camera 20 and/or the storage device 30. In addition, the software interface 50 may be configured to receive instructions entered by the user. Such user instructions may be for requesting digital images from the connected digital camera 20 and/or from the storage device 30 storing digital images. Other instructions entered by the user to the software interface 50 may be for selecting some or all of the displayed digital images (previously received from the connected devices). Some other instructions entered by the user to the software interface 50 may be for processing (e.g., adjusting certain characteristics of) some or all of the displayed digital images.

The software interface 50 can include an inspector panel 52, a browser panel 54 and a viewer panel 56. The panels 52, 54 and 56 of the user interface 50 may be resizable. The inspector panel can include three tabs. A library tab, a metadata tab and an adjustments tab 60. The library tab enables a user to select a project to work on. Once the project is selected in the library tab, the digital images included in the selected project can be displayed in the project browser panel 54. The project browser panel 54 enables the user to select one or more digital images among the digital images included in the selected project. In the example user interface 50 shown in FIG. 1, one digital image 72 is selected. The selected digital image 72 can be displayed as having a highlighted perimeter 73. The selected digital image 72 can also be displayed in a first image frame 74 of the image viewer 56. The user can inspect, rank, or process the selected digital image 72 displayed in the first image frame 74 of the image viewer 56.

The adjustments tab 60 of inspector panel 52 can contain a drop-down menu labeled “Adjustments” 62 that enables a user to select fully customizable adjustments to be applied to the selected digital image 72 displayed in the first image frame 74. The selected adjustments can be displayed under the adjustments tab 60 of the inspector panel 52. An example adjustment selected by the user is labeled “Enhance” 66. As part of the “Enhance” adjustment 66 the user can modify (e.g., using sliders) the contrast, the definition, the saturation and the vibrancy of the selected digital image 72. Another example adjustment selected by the user is labeled “Curves” 68. As part of the “Curves” adjustment 68 the user can modify algorithmically (auto-adjust) the tones and the contrast of the selected digital image 72. In the example illustrated in FIG. 1, adjustments 66 and 68 are applied to the digital image 72 and the adjusted digital image is displayed in the first image frame 74 of the image viewer 56.

However, it can be advantageous for a user to save the applied adjustments 66 and 68 and to apply the saved adjustments to other digital images included in the project currently displayed in the project browser 54, or to any other digital images. The processes disclosed in this specification enable a user to save the applied adjustments as adjustment presets for later use. Additionally, it can be advantageous for the user to apply adjustment presets generated by professional photographers, to digital images accessed on the digital camera 20 and on the storage device 30 storing digital images, either before or after the application of user's own adjustments 66, 68. Such adjustment presets, whether created and saved by the user or generated by and imported from a professional photographer, can be accessed from a dropdown menu labeled “Presets” 80. Note that in this specification the terms “adjustment preset” or simply “preset” are being used interchangeably. Also note that a preset includes one or more adjustments as described in detail below.

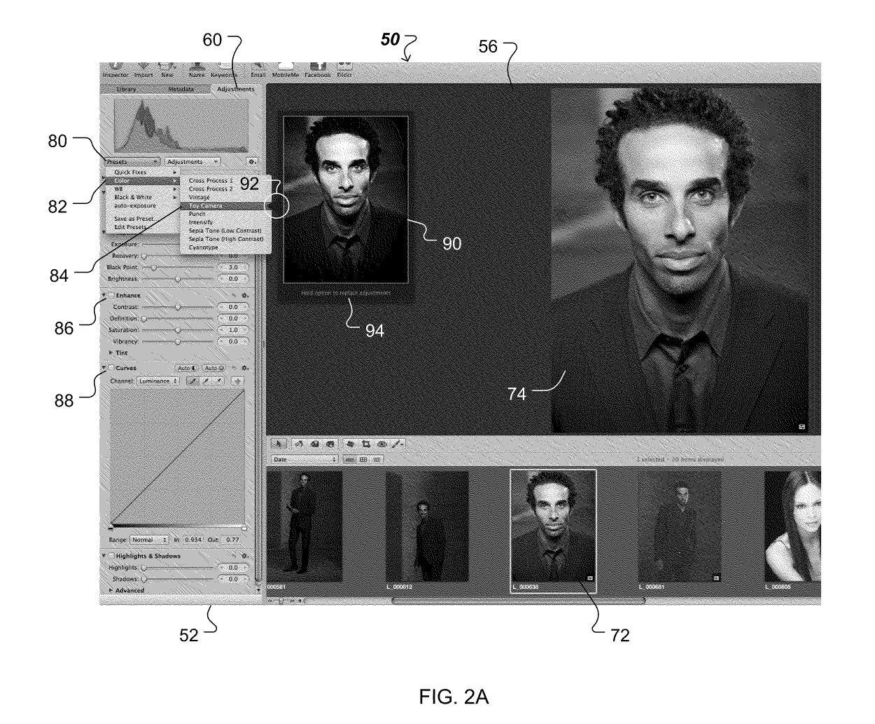

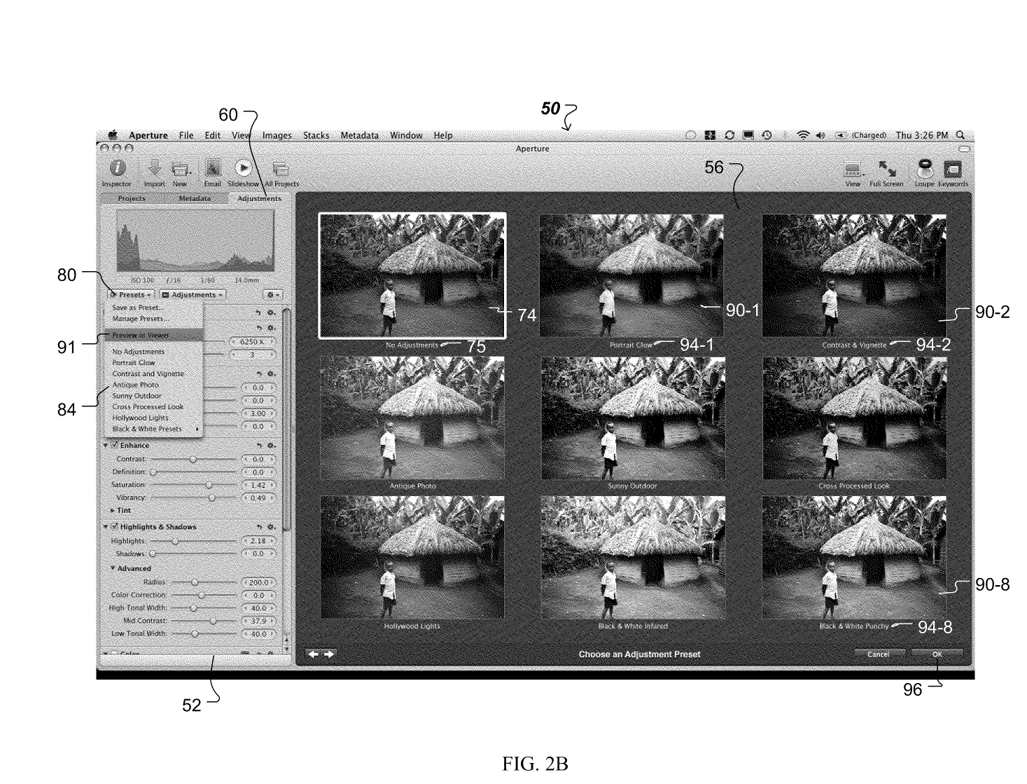

FIG. 2A shows a configuration of a user interface 50 of a digital image manipulation application for applying presets to a digital image. A user can select a digital image 72 from among a set of digital images included in a selected project. The set of digital images from the selected project can be displayed in the project browser panel 54 of the user interface 50. The selected digital image 72 can also be displayed in a first image frame 74 of the image viewer panel 56 of the user interface 50.

The Adjustments tab 60 of the inspector panel 52 includes a Presets dropdown menu 80 that contains multiple preset categories 82. Examples of available preset categories 82 are quick fix adjustments, white balance adjustments, black and white adjustments, and auto-exposure adjustments. In response to highlighting a preset category 82 from the dropdown list 80, a corresponding presets list 84 can be displayed. An example presets list 84 corresponding to the preset category labeled “Color” 82 includes Cross Process, Vintage, Toy Camera, Punch, Intensity, Sepia Tone (separate presets for low and high contrast), Cyanotype, etc. Such imaging effects can mimic styles developed by professional photographers or the look and feel of vintage film stocks.

In response to highlighting a preset from the presets list 84, a preview of the digital image 72 can be displayed in a second image frame 90. The highlighted preset 84 is applied to the preview image displayed in the second image frame 90. The display in the first image frame 74 of the digital image 72 can remain unchanged in response to generation of the preview image in the second image frame 90. This process allows a user to preview the effect of the preset 84 on the digital image 72. Additionally, the second image frame 90 can be spatially separated and distinct from first image frame 74. The second image frame 90 to display the preview image can appear adjacent to the corresponding menu item. For example, a triangle (inscribed in circle 92) having the base on the second image frame and the apex in line and pointing to the highlighted corresponding preset can be used as a graphical connector.

A particular preset 84 can be highlighted when a user positions a cursor over a menu item corresponding to the particular preset. In addition, the preview image in the second image frame 90 can be transient and can go away as soon as the user moves the cursor off that menu item. Therefore, either of display or removal of the preview image can occur in real time from user's perspective. Further, new preview images can be displayed in the second image frame 90 adjacent to corresponding presets as the user moves the cursor through drop-down menu 84 from one preset menu item to another preset menu item. Accordingly, the user can quickly skim from preset to preset to compare styles, and can select to instantly apply a style to the digital image 72.

Upon applying the preset to the digital image 72, the adjustments of the applied preset can be displayed under the adjustments tab 60. In the example implementation shown in FIG. 2A, an adjustment of the applied “Toy camera” preset 84 is labeled “Enhance” 86. The “Enhance” adjustment 86 can have all the adjustment-sliders preset to corresponding adjustment-settings. Some of the adjustment-settings corresponding to the “Enhance” adjustment 86 are contrast, definition, saturation and vibrancy. Another adjustment of the preset 84 is labeled “Curves” 88. The adjustment-settings of the “Curves” adjustment 88 can modify algorithmically (auto-adjust) the tones and contrast of the digital image 72.

The presets applied to digital image 72 can have an adjustment including adjustment-settings that may be applied according to preset values, and can have an adjustment including adjustment-settings that may be applied algorithmically. For example, an adjustment can include “contrast+0.5” AND “compute the automatic exposure composition”. In this example, the “contrast+0.5” adjustment-setting increases the contrast of the digital image 72 by +0.5 regardless of the contrast of the digital image 72 prior to applying the preset. However, the “compute the automatic exposure composition” adjustment-setting is applied algorithmically to the digital image 72, such that the outcome of the auto-exposure operation depends on the initial exposure of the digital image 72.

In another example, a given auto-adjustment can be applied to photo “A” to produce an adjustment “a” of photo “A”. When the given auto-adjustment is applied to photo “B”, the resulting adjustment of photo “B” is “b” and not “a”. In contrast, a predetermined-change (e.g., +n) adjustment can be applied to photo “A” to produce an adjustment “n” of photo “A”. When the preset-change adjustment is applied to photo “B”, the resulting adjustment of photo “B” is also “n”. Thus, the outcome of the given auto-adjustment depends on the characteristics of the picture, while the outcome of the predetermined-change adjustment does not depend on the characteristics of the picture.

In some instances, two conflicting presets (each having one or more adjustments) that may include a common adjustment-setting can be applied sequentially to a digital picture 72. The software application can be configured to automatically replace the adjustments caused by the preset applied first, with the adjustments caused by the preset applied second. This mode of operating the software application can be referred to as the “replace”-mode. Alternatively, the software application can be configured to have the preset applied second process the output of the preset applied first, effectively automatically combining the effects of the first and second-applied presets. This mode of operating the software application can be referred to as the “add”-mode (or “combine”-mode).

In other instances, two sequentially applied presets can include non-conflicting adjustments. In such instances, the effects caused by the first and second-applied presets can be automatically added together (in a linear superposition manner).

Further, the software application can be configured to apply first and second presets sequentially, first in “add”-mode, then to repeat the sequential application of the first and second presets in “replace”-mode. If the outcomes of the two modes of applying the sequential first and second presets are different, the user can be prompted (via a prompt label 94 displayed as part of the second image from 90) to choose between the two modes of performing the sequential first and second presets. Additionally, the sequential first and second presets can be applied manually, can be applied automatically, or one can be applied manually and the other one can be applied automatically. In addition, adjustments of the sequential first and second presets can be based on an algorithm, can be based on a predetermined change, or one can be based on an algorithm and the other one can be based on a predetermined change.

The following examples combine the previously described situations. In a first example, the first preset is based on predetermined settings of the contrast slider. The second preset represents an auto-contrast adjustment. Because the second preset conflicts with the first preset, the outcome of the sequential first and second preset is determined to be the effect of the second preset (the contrast adjustment).

In a second example, adjustments of the first preset are not part of the second preset. The second preset can be a preset black-and-white (B&W) adjustment. Because the second B&W adjustment does not conflict with the first adjustment, the outcome of the sequential first and second presets is determined to be the sum effect of the first and second presets.

Finally, when combined with masking, two different presets can be applied to two different portions of the image. For example, two distinct contrast presets can be applied to the two different portions of the image represented by the area inside and outside a mask, respectively. The mask can be made by a variety of techniques. An example technique for making masks having irregular shapes is brushing. A regular shape mask can be defined by the borders of a rectangle drawn over the image.

FIG. 2B shows another configuration of the user interface 50 of the digital image manipulation application for applying presets to a digital image. A digital image selected by the user can be displayed in the image viewer panel 56 of user interface 50 alongside one or more preview images representing the effect of corresponding one or more presets applied to the digital image. For the example configuration shown in FIG. 2B, the selected digital image is displayed (without adjustments) in an image frame 74 of the image viewer panel 56, and is labeled appropriately by a “No Adjustments” label 75. Further in this example, the one or more preview images are displayed in one or more preview image frames 90-1, 90-2, . . . , 90-8. The preview image frames are labeled 94-1, 94-2, . . . , 94-8 in accordance with the corresponding applied presets.

The Adjustments tab 60 of the inspector panel 52 includes a Presets dropdown menu 80 that contains a list of preset 84. The example presets in the list of presets 84 illustrated in FIG. 2B are Portrait Glow, Contrast and Vignette, Antique Photo, Sunny Outdoor, Cross Process Look, Hollywood Lights, and other Black& White presets. In response to a user choosing the menu item 91 labeled “Preview in Viewer”, the one or more preview images of the adjusted digital image can be simultaneously displayed in the corresponding one or more preview frames 90-1, . . . , 90-8. The display of the digital image in the image frame 74 can remain unchanged in response to generation of the preview images in the one or more image frames 90-1, . . . , 90-8. This process allows a user to preview the effect on the digital image of all the presets listed on the presets list 84. Accordingly, the user can simultaneously preview the available presets to compare styles, and can use the select button 96 to instantly apply a desired style to the digital image.

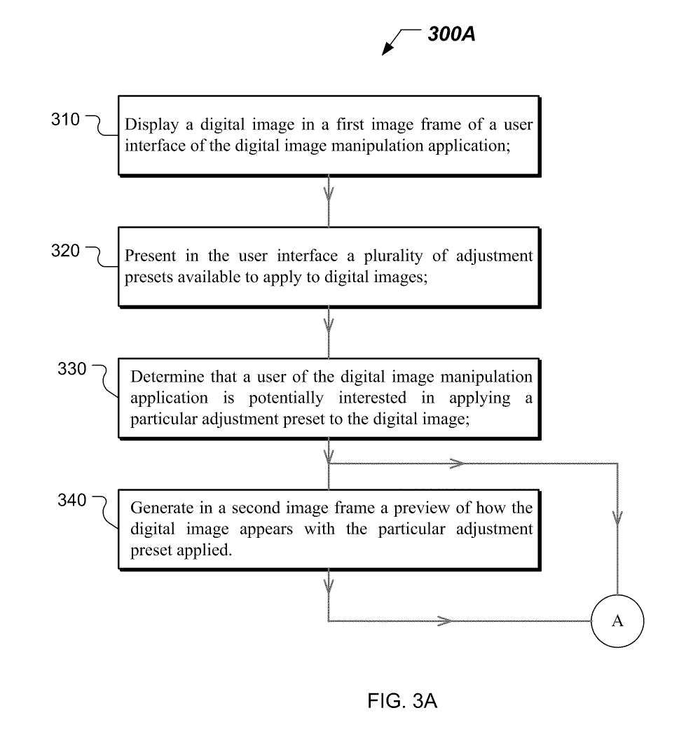

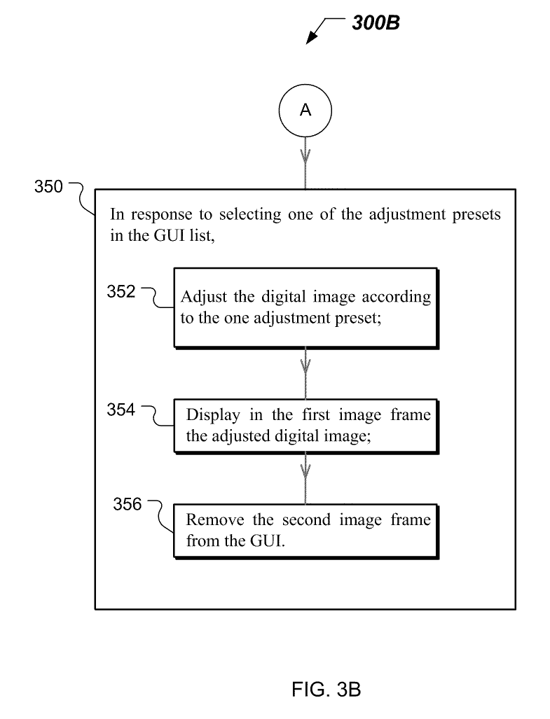

FIGS. 3A-3B are flow charts that show example processes 300A and 300B, respectively, for applying presets to a digital image. The processes 300A and 300B can be implemented as part of a graphical user interface (GUI).

A process 300A can be performed by a digital image manipulation application executing on a computer system. The process 300A includes displaying 310 a digital image in a first image frame of a user interface of the digital image manipulation application. The process 300A also includes presenting 320 in the user interface a plurality of presets available to apply to digital images. Further, the process 300A includes determining 330 that a user of the digital image manipulation application is potentially interested in applying a particular preset to the digital image.

The process 300A can continue with generating 340 in a second image frame a preview of how the digital image appears with the particular preset applied. Further, the generated preview image can change dynamically in response to indicating another preset upon placing a cursor over the other preset in a GUI list.

Additionally, after performing either of steps 330 and 340, the process 300A can continue with the process 300B. In response to user selection of one of the presets in the GUI list (350), the process 300B includes adjusting 352 the digital image according to the one preset. The process 300B further includes displaying 354 in the first image frame the adjusted digital image. Furthermore, the process 300B includes removing 356 the second image frame from the GUI.

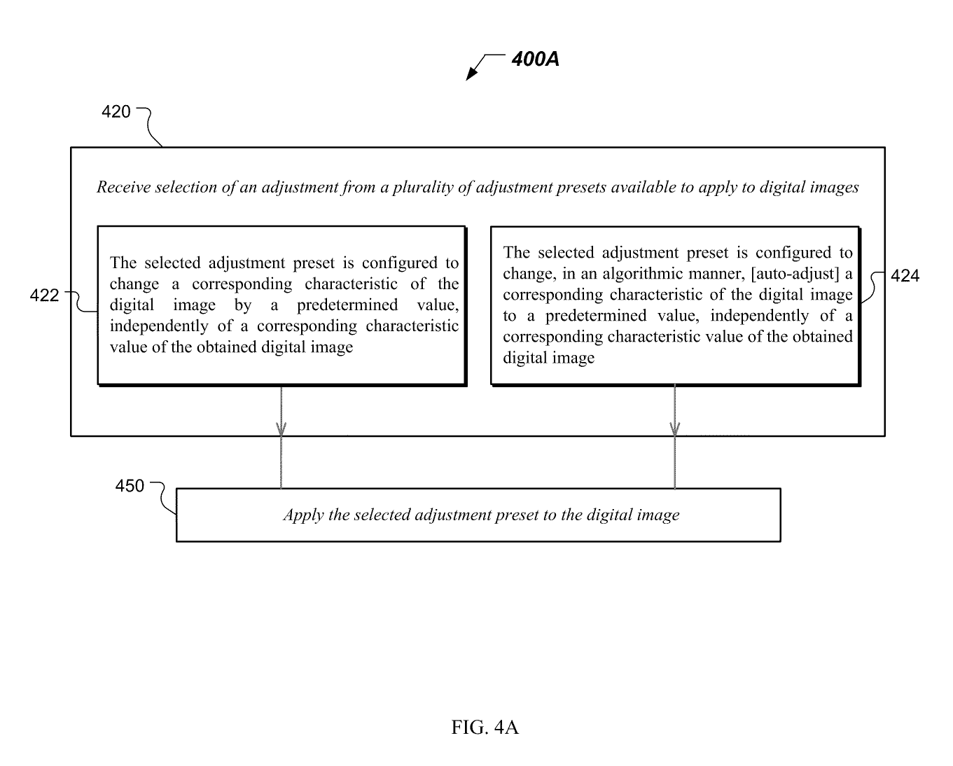

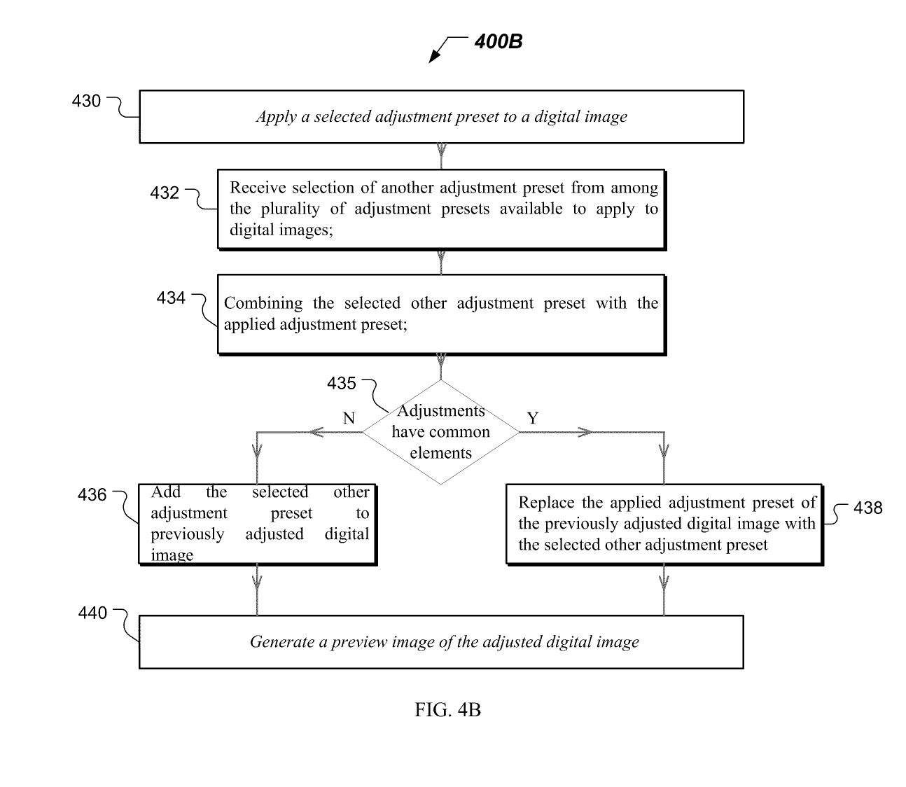

FIGS. 4A-4B are flow charts 400A and 400B, respectively, that show aspects of an example process for applying presets to a digital image. For example, the processes 400A and 400B can be applied in combination with processes 300A and 300B described above in connection with FIGS. 3A-3B.

The flow chart in FIG. 4A shows that the process 400A can include receiving 420 a selection of an adjustment from a plurality of presets available to apply to digital images. The selected preset can be applied, for example, to the digital image displayed in the first image frame of the user interface of the digital image manipulation application, as described in connection with FIGS. 2 and 3A. In an aspect 422 of the process 400A, the selected preset can be configured to change a corresponding characteristic of the digital image by a predetermined value, independently of a corresponding characteristic value of the digital image. In an aspect 424 of the process 400A, the selected preset can be configured to change, in an algorithmic manner, (or auto-adjust) a corresponding characteristic of the digital image to a predetermined value, independently of a corresponding characteristic value of the digital image. Example characteristics of the digital image are a contrast, a brightness, an exposure, etc. The process 400A can continue with applying 450 the selected preset to the digital image displayed in the first image frame.

The flow chart in FIG. 4B shows that the process 400B can include applying 430 the selected preset to a digital image. The adjusted digital image can be, for example, the digital image displayed in the first image frame of the user interface of the digital image manipulation application, as described in connection with FIGS. 2 and 3B. The process 400B can also include receiving 432 selection of another preset to be applied to the adjusted digital image. The process 400B can combine 434 the selected other preset with the preset applied to the digital image prior to step 432. For example, the applied preset can be configured to adjust a first characteristic of a digital image, and the received other preset can be configured to adjust a second characteristic of the digital image.

The process 400B further includes determination 435 of whether the applied preset and the other received preset have common adjustment-settings. The process 400B can continue by adding 436 the other preset to the preset previously applied to the digital image, if the first and second characteristics of the image have no common adjustment-settings. Alternatively, the process 400B can continue by replacing 438 the preset previously applied to the digital image with the other preset, if the first and second characteristics of the image have common adjustment-settings. The replacing step 438 includes removing the effects of the preset previously applied to the digital image, and then applying the other received preset. After either of steps 436 and 438, the process 400B can include, generating 440 a preview of the digital image to display the effects of the combined presets.

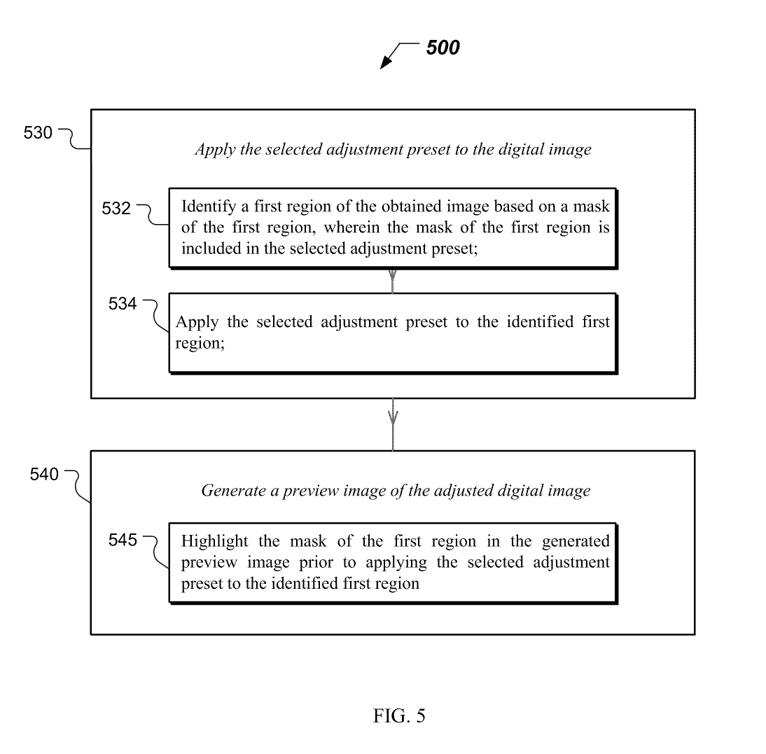

FIG. 5 is a flow chart 500 that shows additional aspects of an example process for applying presets to a digital image. For example, the process 500 can be applied in combination with processes 300A and 300B described above in connection with FIGS. 3A-3B.

The flow chart in FIG. 5 shows that the process 500 can include applying 530 the selected preset to a digital image. The selected preset can be applied, for example, to the digital image displayed in the first image frame. However, presets can be applied to the entire image or to portions of the image. Portions of the image can be selected using a mask, e.g., a brushing mask or a rectangular mask. The process 500 can continue with identifying 532 a first region of the image based on a mask of the first region. The mask of the first region can be included in the selected preset. The process 500 further includes applying the selected preset to the identified first region. Notably, presets can be applied selectively to areas of the image overlapped by the mask. The adjustment settings of the applied presets and the mask can be saved as part of a new user defined preset.

Also as part of process 500, a preview image of the adjusted digital image can be generated 540 in the second image frame. The process 500 can then highlight 545 the mask of the first region in the generated preview image prior to applying the particular preset to the identified first region. The highlighting can include displaying the perimeter (contour) of the first region mask in red, for instance.

The digital computer 10 can be configured to modify a selected preset in accordance with a combination of the disclosed processes 300A-B, 400A-B and 500. For example, the selected preset can be modified by changing one or more settings of the selected preset. The various settings of a preset can be modified via multiple adjustment-sliders to create a certain look. In some implementations, fewer (than all) adjustment-sliders may be available for a user. For example, a preset can be generated and saved to allow a user to only manipulate one adjustment-slider. For example in the case of an enhance adjustment, a user may be permitted to adjust the saturation, but not the contrast. The slider settings corresponding to the certain look can be saved under a new preset labeled, e.g., “certain look”. In addition, a mask can be used to define a second region of the adjusted digital image. The selected preset can be further modified by changing one or more adjustment settings to be applied only to the second region.

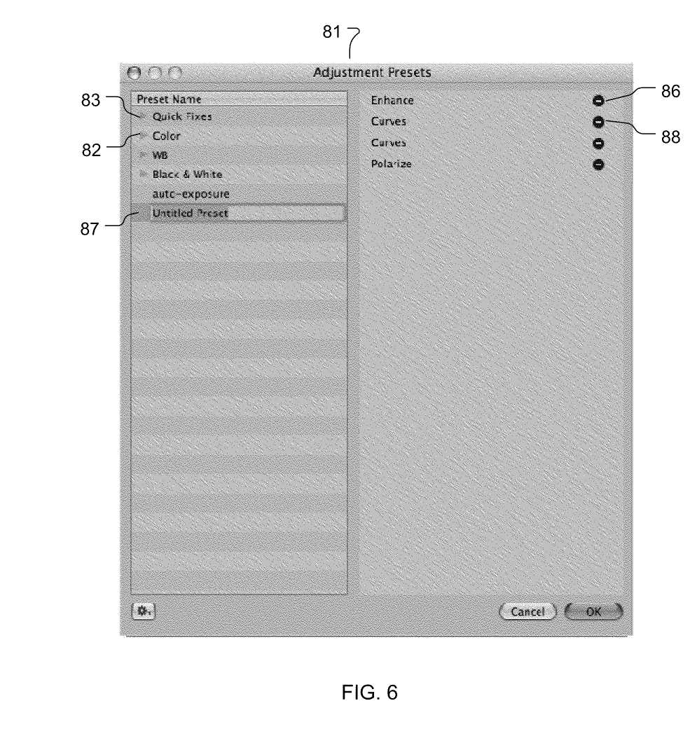

FIG. 6 shows an additional user interface 81 configured to enable a user of the application (for previewing and applying presets to a digital image) to save a modified preset to a new preset. The newly saved (and untitled) preset 87 can be added to the existing plurality of presets available to apply to digital images. A user interface 81 can display the existing preset categories labeled, e.g., “Color” 82 and “Quick fixes” 83. Additionally, the user interface 81 lists the adjustments included in the newly saved untitled preset 87. In the example illustrated in FIG. 6, the adjustments included in the newly saved and untitled preset 87 are Enhance, two Curves adjustments, and Polarize.

Accordingly, the software application (for previewing and applying presets to a digital image) allows a user to create presets or import presets from others. A combination of adjustment settings can be saved as a personal preset that can be applied later to other digital images. The saved presets can be shared or imported to enable sharing of styles among photographers.

As addressed above in connection with FIG. 2A-2B, the processes disclosed in this specification can enable a user to preview in one or more window frames professional imaging effects applied to a digital image, and then to apply the previewed professional imaging effects to the digital image that is displayed in a first image frame. Any combination of adjustment settings, including auto-exposure and auto-levels can be applied, based on the foregoing processes, to images that have been loaded in the application prior to applying the presets.

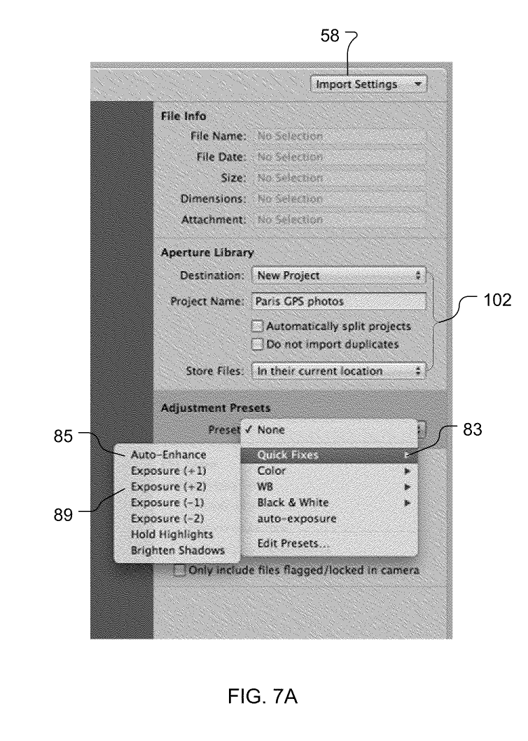

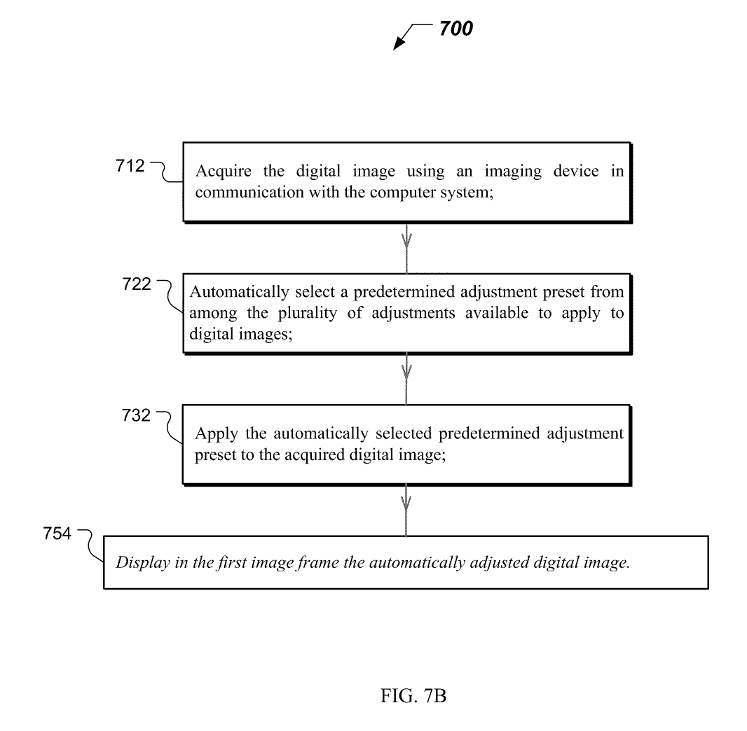

Alternatively, presets can be applied to images as the images are being imported from storage, e.g., a disk or a camera. FIG. 7A shows a user interface 58 of the application for applying presets to a set of digital images, in batch mode. Selection by a user of a dropdown menu item labeled “Import Settings” exposes the available preset categories 82. As described above in connection with FIG. 2A, a presets list 84 can correspond to a preset category 82. In the example user interface shown 58 in FIG. 7A, the preset category labeled “Quick fixes” 83 can include Auto-Enhance 85, four Exposure ({−2, −1, +1, +2}) adjustments 89, Hold Highlights and Brighten Shadows.

For example, a preset vintage look adjustment (from the Color preset category) can be applied to photos as the photos are being imported from storage. Additionally, photos can be acquired in tethered mode by controlling a camera in communication with a computer running the software application. A preset from the auto-exposure or black-and-white categories can be applied to all photos captured by the camera operated in tethered mode by the software application.

FIG. 7B is a flow chart that shows an example process 700 for applying presets to a set of digital images in batch mode. Moreover, the process 700 can be applied in combination with processes 300A and 300B described above in connection with FIGS. 3A-3B, 4A-4B and 5.

The flow chart in FIG. 7B shows that the process 700 can include acquiring 712 the digital image using an imaging device in communication with the computer system. Alternatively, the process 700 may include obtaining the digital image from a memory device in communication with the computer system. Further, the process 700 can automatically select 722 a predetermined adjustment preset from among the plurality of adjustments available to apply to digital images. Furthermore, the process 700 continues with applying 732 the automatically selected predetermined adjustment preset to the acquired/obtained image. The automatically adjusted image can then be displayed 754, for example, in the first image frame.

A multitude of computing devices may be used to implement the systems and methods described in this document, as either a client or as a server or plurality of servers. A computing device can be implemented in various forms of digital computers, such as laptops, desktops, workstations, personal digital assistants, servers, blade servers, mainframes, and other appropriate computers. Another computing device can be implemented in various forms of mobile devices, such as personal digital assistants, cellular telephones, smartphones, and other similar computing devices. Additionally, computing devices can include Universal Serial Bus (USB) flash drives. The USB flash drives may store operating systems and other applications. The USB flash drives can include input/output components, such as a wireless transmitter or USB connector that may be inserted into a USB port of another computing device. The components described here, their connections and relationships, and their functions, are meant to be exemplary only, and are not meant to limit implementations of the inventions described and/or claimed in this document.

A computing device can include a processor, memory, a storage device, a high-speed interface connecting to memory and high-speed expansion ports. The computing device can further include a low speed interface connecting to a low speed bus and a storage device. Each of the above components can be interconnected using various busses, and may be mounted on a common motherboard or in other manners as appropriate. The processor can process instructions for execution within the computing device, including instructions stored in the memory or on the storage device to display graphical information for a GUI on an external input/output device, such as a display coupled to high speed interface. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory can store information within the computing device. In one implementation, the memory can be a volatile memory unit or units. In another implementation, the memory can be a non-volatile memory unit or units. The memory may also be another form of computer-readable medium, such as a magnetic or optical disk.

The storage device can provide mass storage for the computing device. In one implementation, the storage device may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory, the storage device, or memory on processor.

The high speed controller can manage bandwidth-intensive operations for the computing device, while the low speed controller can manage lower bandwidth-intensive operations. Such allocation of functions is exemplary only. In one implementation, the high-speed controller can be coupled to memory, to a display (e.g., through a graphics processor or accelerator), and to high-speed expansion ports, which may accept various expansion cards. In the implementation, low-speed controller can be coupled to the storage device and the low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms. For example, it may be implemented as a standard server, or multiple times in a group of such servers. It may also be implemented as part of a rack server system. In addition, it may be implemented in a personal computer such as a laptop computer. Alternatively, components from computing device may be combined with other components in a mobile device. Each of such devices may contain one or more computing devices or mobile devices, and an entire system may be made up of multiple computing devices and mobile devices communicating with each other.

A mobile device can include a processor, memory, an input/output device such as a display, a communication interface, and a transceiver, among other components. The mobile device may also be provided with a storage device, such as a microdrive or other device, to provide additional storage. Each of the above components is interconnected using various buses, and several of the components may be mounted on a common motherboard or in other manners as appropriate.

The processor can execute instructions within the mobile device, including instructions stored in the memory. The processor of the mobile device may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the mobile device, such as control of user interfaces, applications run by the mobile device, and wireless communication by the mobile device.

The processor of the mobile device may communicate with a user through control interface and display interface coupled to a display. The display may be, for example, a Thin-Film-Transistor Liquid Crystal display or an Organic Light Emitting Diode display, or other appropriate display technology. The display interface may include appropriate circuitry for driving the display to present graphical and other information to a user. The control interface may receive commands from a user and convert them for submission to the processor of the mobile device. In addition, an external interface may provide in communication with processor of the mobile device, so as to enable near area communication of the mobile device with other devices. The external interface may provide, for example, for wired communication in some implementations, or for wireless communication in other implementations, and multiple interfaces may also be used.

The memory stores information within the computing mobile device. The memory can be implemented as one or more of a computer-readable medium or media, a volatile memory unit or units, or a non-volatile memory unit or units. An expansion memory may also be provided and connected to the mobile device through an expansion interface, which may include, for example, a SIMM (Single In Line Memory Module) card interface. Such expansion memory may provide extra storage space for the mobile device, or may also store applications or other information for the mobile device. Specifically, expansion memory may include instructions to carry out or supplement the processes described above, and may include secure information also. Thus, for example, expansion memory may be provide as a security module for the mobile device, and may be programmed with instructions that permit secure use of device. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory, expansion memory, or memory on processor that may be received, for example, over transceiver or external interface.

The mobile device may communicate wirelessly through communication interface, which may include digital signal processing circuitry where necessary. Communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver. In addition, short-range communication may occur, such as using a Bluetooth, WiFi, or other such transceiver (not shown). In addition, GPS (Global Positioning System) receiver module may provide additional navigation- and location-related wireless data to the mobile device, which may be used as appropriate by applications running on the mobile device.

The mobile device may also communicate audibly using audio codec, which may receive spoken information from a user and convert it to usable digital information. Audio codec may likewise generate audible sound for a user, such as through a speaker, e.g., in a handset of the mobile device. The sound may include sound from voice telephone calls, may include recorded sound (e.g., voice messages, music files, etc.) and may also include sound generated by applications operating on the mobile device.

The mobile computing device may be implemented in a number of different forms. For example, it may be implemented as a cellular telephone. It may also be implemented as part of a smartphone, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a digital image manipulation application executing on a computer system, the method comprising:
displaying a digital image in a first image frame of a user interface of the digital image manipulation application;
presenting in the user interface a plurality of adjustment presets available to apply to digital images;
determining that a user of the digital image manipulation application is potentially interested in applying one or more adjustment presets to the digital image; and
generating, in one or more other image frames, previews of how the digital image appears with the corresponding one or more adjustment presets applied.

2. The method of claim 1, wherein a digital image comprises either an individual still image or a frame of a movie.

3. The method of claim 1, wherein the user interface is a graphical user interface (GUI), and wherein the one or more image frames consist of a second image frame.

4. The method of claim 3, wherein the generated preview image is displayed in the second image frame, and changes dynamically in response to indicating another adjustment preset upon hovering a cursor over the other adjustment preset in a GUI list.

5. The method of claim 4, wherein in response to user selection of one of the adjustment presets in the GUI list, the method further comprises:
adjusting the digital image according to the one adjustment preset;
displaying in the first image frame the adjusted digital image; and
removing the second image frame from the GUI.

6. The method of claim 5, further comprising:
modifying the one adjustment preset, wherein the modifying comprises one or more of:
receiving first changes to one or more characteristics of the one adjustment preset;
receiving a mask to define a second region of the adjusted digital image; and
receiving second changes to one or more characteristics of the one adjustment preset to be applied only to the second region;
saving the modified one adjustment preset to a new adjustment preset; and
adding the new adjustment preset to the plurality of adjustment presets available to apply to digital images.

7. The method of claim 1, wherein a particular adjustment preset is configured to change a corresponding characteristic of the digital image by a predetermined value, independently of a corresponding characteristic value of the digital image.

8. The method of claim 1, wherein a particular adjustment preset is configured to change, in an algorithmic manner, a corresponding characteristic of the digital image to a predetermined value, independently of a corresponding characteristic value of the digital image.

9. The method of claim 1, wherein generating the preview image comprises:
identifying a first region of the image based on a mask of the first region, wherein the mask of the first region is included in the particular adjustment preset; and
applying a particular adjustment preset to the identified first region.

10. The method of claim 9, further comprising:
highlighting the mask of the first region in the generated preview image prior to applying the particular adjustment preset to the identified first region.

11. The method of claim 1, further comprising:
determining that the user is potentially interested in applying a second adjustment preset after having applied a first adjustment preset to the digital image.

12. The method of claim 11, wherein the first adjustment preset is configured to adjust a first characteristic of an image, and the second adjustment preset is configured to adjust a second characteristic of the image, the method further comprising:
adding the second adjustment preset to the first adjustment preset previously applied to the digital image, if the first and second characteristics of the image have no common elements; and
replacing the first adjustment preset previously applied to the digital image with the second adjustment preset, if the first and second characteristics of the image have common elements.

13. A system comprising:
a storage device for storing media content including a digital image; and
a computing device communicatively coupled with the storage device, wherein the computing device executes a digital image manipulation application, and wherein the application is configured to perform operations comprising:
displaying the digital image in an image frame of a user interface of the digital image manipulation application;
providing a plurality of adjustment presets available to apply to digital images;
receiving from a user of the application an indication of potential interest in applying one or more adjustment presets to the digital image; and
displaying, in at least another image frame, one or more previews of the digital image adjusted based on the corresponding one or more adjustment presets.

14. The system of claim 13, wherein the available adjustment presets are listed in a drop-down menu in the user interface.

15. The system of claim 14, wherein new preview images are displayed in a second image frame disposed adjacently to corresponding adjustment presets as the user moves a cursor through the drop-down menu from one adjustment preset menu item to another adjustment preset menu item.

16. The system of claim 14, wherein the drop-down menu in the user interface includes a menu item to simultaneously display one or more image frames which show the generated previews corresponding to the one or more adjustment presets.

17. The system of claim 13, further comprising:
a memory device in communication with the computing device, wherein
the application is further configured to perform operations comprising:
obtaining the digital image from the memory device.

18. The system of claim 13, further comprising:
an imaging device in communication with the computing device, wherein
the application is further configured to perform operations comprising:
acquiring the digital image using the imaging device.

19. The system of claim 18, wherein the application is further configured to perform operations comprising:
automatically selecting a predetermined adjustment from among the plurality of adjustments available to apply to digital images; and
applying the automatically selected predetermined adjustment to the acquired image.

20. A computer readable medium encoded with a computer program, the program comprising instructions that when executed by a processor of a computing device cause the processor to perform operations comprising:
displaying a digital image in a primary image frame of a user interface; providing in the user interface a plurality of adjustment presets available to apply to digital images;
determining that a user of the computer program is potentially interested in applying one or more of the plurality of adjustment presets to the digital image; and
generating, in one or more secondary image frames, previews of how the digital 126 image appears with the corresponding one or more adjustment presets applied.

21. The computer readable medium of claim 20, wherein the digital image in the primary image frame remains unchanged in response to generation of preview images.

22. The computer readable medium of claim 20, wherein the one or more secondary image frames are spatially separated and distinct from primary image frame.

23. The computer readable medium of claim 20, wherein to determine that the user is potentially interested in a particular adjustment preset the processor performs operations comprising:
detecting that user has positioned a cursor over a menu item corresponding to the particular adjustment preset.

24. The computer readable medium of claim 23, wherein a preview image appears in a secondary image frame disposed adjacently to the corresponding menu item.

25. The computer readable medium of claim 24, wherein:
the preview image is transient and goes away as soon as user moves the cursor off that menu item, and
either of display or removal of the preview image occurs in real time from a user's perspective.
